(19) United States
(12) Patent Application Publication
(10) Pub. No.: US 2003/0060205 A1
(43) Pub. Date: Mar. 27, 2003

(54) Cell and sector optimization system and methods

(76) Inventor: Joseph Shapira, Haifa (IL)

Correspondence Address: PILLSBURY WINTHROP, LLP, P.O. BOX 10500, MCLEAN, VA, 22102, US

(21) Appl. No.: 10/181,271

(22) PCT Filed: Jan. 26, 2001
(86) PCT No.: PCT/IB01/00264

(51) Int. Cl. H04B 7/00; H04Q 7/20

(52) U.S. Cl. 455/446; 455/562; 455/522; 455/423

(57) ABSTRACT

An antenna system and arrangement as well as systems for controlling antenna beam patterns to provide improved cellular communications including a method for controlling the coverage area of a base station in a cellular telecommunications system including a plurality of mobile stations. The method including determining the positions of the mobile stations within the coverage area of the base station, determining the boundaries of the coverage area between adjacent cells or sectors, directing a corresponding plurality of individual beams from the base station to the positions of the mobile stations of from the mobile stations to the base station, and co-ordinating the direction and intensity of the plurality of individual beams to optimize the coverage of the base station, the coordination accomplished by adjusting the controls of the antenna arrays relative to one another so as to establish the boundaries of the coverage area.

### RELATED APPLICATION DATA

Priority is hereby claimed to U.S. Provisional Patent Application No. 60/177,659 entitled “CELL AND SECTOR OPTIMIZATION SYSTEM AND METHODS”, filed on Jan. 27, 2000, the content of which is hereby expressly incorporated herein by reference thereto, in its entirety. Other related applications are specifically referenced below.

### BACKGROUND OF THE INVENTION

### RESERVATION OF COPYRIGHT

The disclosure of this patent document contains material, which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

1. Field of the Invention

The present invention relates to certain cellular communications systems and base station technology.

2. Description of Background Information

Today's cellular communication systems are subjected to ever-increasing user demands. Current subscribers are demanding more services and better quality while system capacities are being pushed to their limits. The challenge, therefore, is to provide feasible and practical alternatives that increase system capacity while achieving better grades of service.

Typically, for each geographic cell, cellular communication systems employ a base station (BS) with an omni-directional antenna that provides signal coverage throughout the cell. One way to increase the communications capacity, is to split the geographic cell into a plurality of smaller cells (i.e., cell-splitting) by deploying additional BSs within the cell area, thereby increasing the number of frequencies that can be re-used by the system. This cell-splitting, however, can be both cost-prohibitive and environmentally-deterred as conventional BS equipment include antenna arrangements which are expensive and often too bulky and unaesthetic for prevailing community standards.

An alternative approach to improving system capacity and maintaining service quality is to angularly divide the geographic cells into sectors (i.e., sectorize) and deploy BS antennae that radiate highly-directive narrow beam patterns to cover designated sectors. The directive beam patterns can be narrow in both the azimuthal and elevation plane and, by virtue of their directional gain, enable mobile stations (MSs) to communicate with the BS at longer distances. In addition, system capacity increases as the sectorized cells are not as susceptible to interference from adjacent cells.

The narrow beams used to form beam patterns for given coverage areas are optimized to improve performance of the wireless network. An ideal goal is to provide exceptional service quality (e.g., no dropped calls), enhanced capacity, low per-site costs enabled by large coverage areas, and long battery service periods for MSs. There are various methods for optimizing the antenna arrangement For example, wireless systems engineers have historically employed BS design rules regarding RF propagation-based coverage in order to “balance the link.” This approach involves controlling the BS antenna gains and antenna heights for transmission and reception, BS transmit power levels, and BS receive sensitivity parameters. These different parameters are selected to provide approximately equal coverage for the MS-to-BS link (i.e., reverse link) as is provided for the BS-to-MS link (i.e., the forward link).

A need still exists to further lower costs of deployment and operations and to provide better coverage/capacity at lower costs. Accordingly, steps have been taken to introduce new technologies, such as CDMA technologies, for example, which can operate in environments involving high intra-system interference and yet provide exceptionally high capacity with low transmit power levels. These new environments and technologies require even more sophisticated network and design approaches and interference mitigation strategies.

There exists a need for improvements in antenna systems and arrangements as well as systems for controlling antenna beam patterns in light of the above-identified issues.

### BRIEF DESCRIPTION OF THE FIGURES

FIG. 1 shows a receive side clever antenna arrangement, which is provided with array plane control;

FIG. 2 shows a transmit side clever antenna arrangement, which is provided with array plane control;

FIG. 3 shows a receive side clever antenna arrangement, which is provided with beam plane control;

FIG. 4 shows a transmit side clever antenna arrangement, which is provided with beam plane control;

FIGS. 5A and 5B show alternative “switching type” amplitude control mechanisms for the beam plane control in FIGS. 3 and 4; and

FIG. 6 is a flow chart of an optimization process.

### DETAILED DESCRIPTION

In U.S. application Ser. No. 09/357,844 entitled “ACTIVE ANTENNA ARRAY CONFIGURATION AND CONTROL FOR CELLULAR COMMUNICATION SYSTEMS” filed on Jul. 21, 1999, and U.S. application Ser. No. 09/357,845 entitled “SCALABLE CELLULAR COMMUNICATIONS SYSTEM” filed on Jul. 21, 1999, the contents of which are hereby incorporated by reference in their entireties, the optimization of cellular networks was discussed. Among other features and technologies disclosed, a network optimization process was defined which in general involved the management of inter-cell interference by appropriately controlling the physical size of a region known as the Soft Hand-Off (SHO) Zone. The optimization process identified the reverse link SHO Zone by locating the inter-cell boundaries, and then moving the pilots' coverage to form SHO boundaries symmetrically around the reverse link boundaries. Use was also made of the Effective Isotropic Radiated Power (EIRP) shaping of the signal energy associated with pilots of the respective cells by employing beam shaper arrays (“The Shaper”) and by controlling the respective pilots' radiated power values.

The optimization of the SHO zone may be used in connection wish the intra-cell optimization of the capacity and performance by applying user-specific coverage shaping (i.e., shaping on a per-beam user basis; sometimes referred to herein as “smart antenna”), together with the coverage shaping techniques for the entire array (which may correspond to an entire sector or cell; sometimes referred to herein as “clever antenna”).

Smart Antennas in CDMA

A “smart antenna” may comprise a system having an antenna array (or arrays), and a beam forming network controlled by certain optimization algorithms. For this discussion, an assumption is made that the smart antenna is located at the base station. It is noted that smart antennas may also be employed at the Mobile Station. On the Reverse link, the smart antenna optimizes performance of each channel (e.g., maximizes the Signal to Interference Ratio, or minimizes the Frame Error Rate for that user/channel, etc.). On the Forward link, the smart antenna optimizes the performance of each of the Mobile Stations (MS) under its control by allocating the optimal value of radio link resources (e.g., power, multipath diversity).

In the following discussion, the term “adaptive antenna” is used synonymously with smart antenna. Narrow-band systems, using Frequency division multiple access (FDMA) or Time division multiple access (TDMA), differ from CDMA systems in the application of “smart antennas” in the following way. For FDMA and TDMA, the number of interferers is small, and each interferer may degrade the performance of one user's link. However, in the case of a CDMA cell, there are many more interferers compared to the number of controls (degrees of freedom) available by employing the adaptive antenna, but each one of the interferers contributes little interference. The adaptive antenna arrays in FDMA and TDMA systems are generally employed to eliminate distinct interferers by forming nulls in these directions, or to minimize radiation (or reception) in the directions of groups of such interferers. For FDMA and TDMA systems, the shape of the sidelobes of the radiation pattern is very important. The CDMA adaptive antenna array generally adapts to maximize its gain toward the desired user, while the detailed shape of the sidelobes is secondary in its importance.

In either case (FDMA/TDMA or CDMA), each adaptive antenna operates autonomously within the cell to optimize the performance of that cell. Intercell interference has been previously handled by an iterative process controlled by each respective autonomous array, characterized by a lack of coordination among those adaptive arrays operating in a cluster of cells or sectors.

Control of the Soft Hand-off (SHO) Zone is important for CDMA systems, and problems with the SHO Zone may result in reduced capacity, dropped calls, and degraded FER. Previous “smart antennas,” which use adaptive antennas operating autonomously within the cell to optimize the performance of that cell, do not appropriately control the SHO Zone.

The “Clever Antenna”

While the “smart antenna” maximizes the capacity within the cell by maximizing the performance for each user, it does not maximize the capacity within the SHO, nor does it maximize the overall capacity of the network. The Clever Antenna is a means of signal radiation management offering two tiers of coverage control: a “smart antenna” within the cell that controls the performance of each user within each cell, and an overall cell boundary shaper, that controls the SHO window boundaries, and thereby the interference between and among the cells. Whereas the “smart antenna” can use the weights in an array antenna to form a pattern that maximizes the SNIR (Signal to Interference and Noise), or minimize BER, to a particular user in the cell, where there is a separate set of weights for each user. The Clever Antenna provides a higher layer that trades-off these processes between users in different cells and maximizes the capacity in a cell cluster.

One form of “smart antenna” includes the bus matrix and the individual set of controls (on a per-user basis) that form the shape of the receive pattern (spatial filter). The coverage shaping controls located at the array plane (at the output of each antenna element) shape the overall coverage and form a coverage envelope within which each of the users' pattern is described and bounded. There are various known adaptive algorithms for controlling the “Smart Antenna.” For example, a simple control in a CDMA system may be employed by beam steering through a single control parameter (the angle or azimuth of maximum radiation). This simple control falls short by at most 3 dB from the highest performance bound of a “smart antenna” for CDMA (a non-physical bound, relating to a zero antenna with sidelobes all together), and by typically 10% from any implementation of a fully adaptive antenna array, and is a preferred choice in some cases.

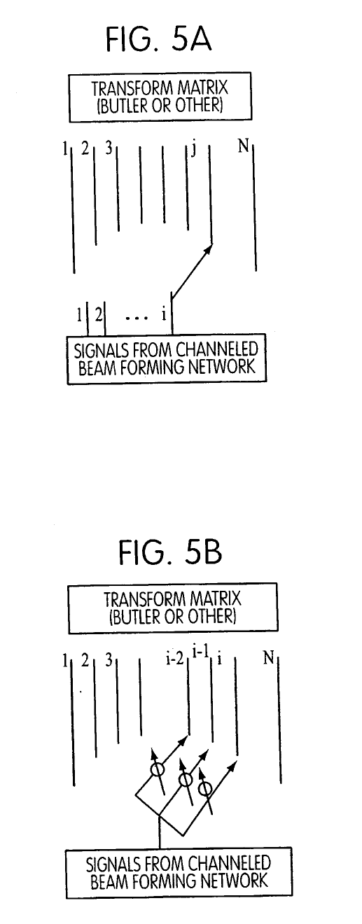

The choice between the use of array-plane control and beam-plane control depends on the specific embodiment. The nature of the controls provided for the array-plane method are mainly variable phase controls, with a small amplitude change, while those provided for the beam-plane method are mainly amplitude controls, and may be replaced by switches in a simple embodiment. These are described in FIGS. 5A and 5B, where the “simple switch” embodiment (FIG. 5A) may be enhanced by a “three-arm switch” embodiment that allows for a smooth transition between and among the beams (FIG. 5B).

The related application Ser. No. 09/357,844, entitled “ACTIVE ANTENNA ARRAY CONFIGURATION AND CONTROL FOR CELLULAR COMMUNICATION SYSTEMS” filed on Jul. 21, 1999 discloses an act A1706, for a given cell cluster (e.g., three adjacent cells as shown in FIG. 17B), a determination using MS information (e.g., information concerning the locations and power levels of respective MSs within pertinent areas, and statistics of the power control commands to each MS by the BTSs participating in the SHO) is then made as to where the boundary line exists between adjacent cells or sectors. These boundary lines demarcate the hand-off boundaries, which correspond to the center of the soft hand-off zones SH1, SH2, SH3, and SH4 for the reverse link.

The determination of these boundary lines over the reverse link may be made as follows:

Each MS (Mobile Station) receives Power Control (PC) Commands 800 times each second, based on the TIA IS-95 standard, and at a higher power control update rate in the third generation wireless standards. These PC commands are either UP or DOWN. While in the SHO zone, the MS receives such commands from all the cells or sectors involved in the SHO process (two sectors/cells or more). The cell with the highest link margin sends mostly DOWN commands, while the opposite is true for the others. The analysis of the PC commands thus provides information on the position of the MS relative to the cell boundary (pertaining to the radio links for all the cells engaged in the SHO balancing process):

The MS is deeper in the cell (closest to the cell site) when the average of PC commands is DOWN

The larger the Standard Deviation in the statistics of the PC commands—the closer is the MS to the boundary.

The MS is on the boundary when the averages of all cells involved is balanced.

Implementation of this analysis requires that the report to the PC commands, or its statistics, is received via the network management system at the network control center.

Measurement of the Coverage of the Pilots (The Ec/Io Map)

Each MS measures the Ec/Io of all pilots periodically, according to a priority scheme.

This information, together with the position location of the MS (which may be available as a result of a special radiolocation or 911 service, or otherwise) provides the coverage mapping of all the pilots in range. The sampling resolution of this map depends on the number of MS in the SHO zone.

In the absence of position location information, the map may be constructed by partial location information (e.g., radial distance extracted from the time-of-arrival), plus physical reasoning on the continuation of each pilot's coverage. In addition, a specialized Sensor MS (a stationary unit) can be placed by the network operator at sampling points in SHO areas, to report these values.

Software Control of the Clever Antenna

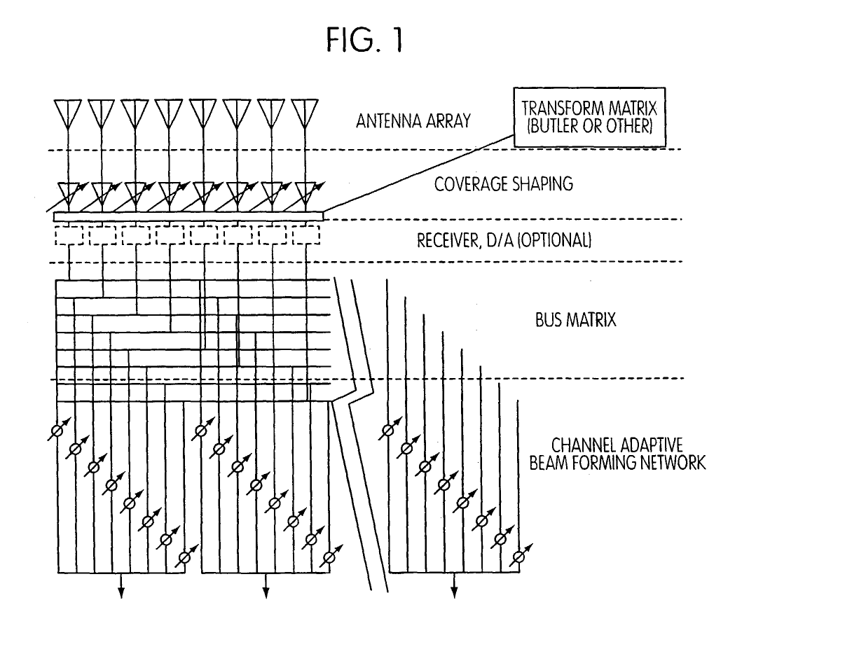

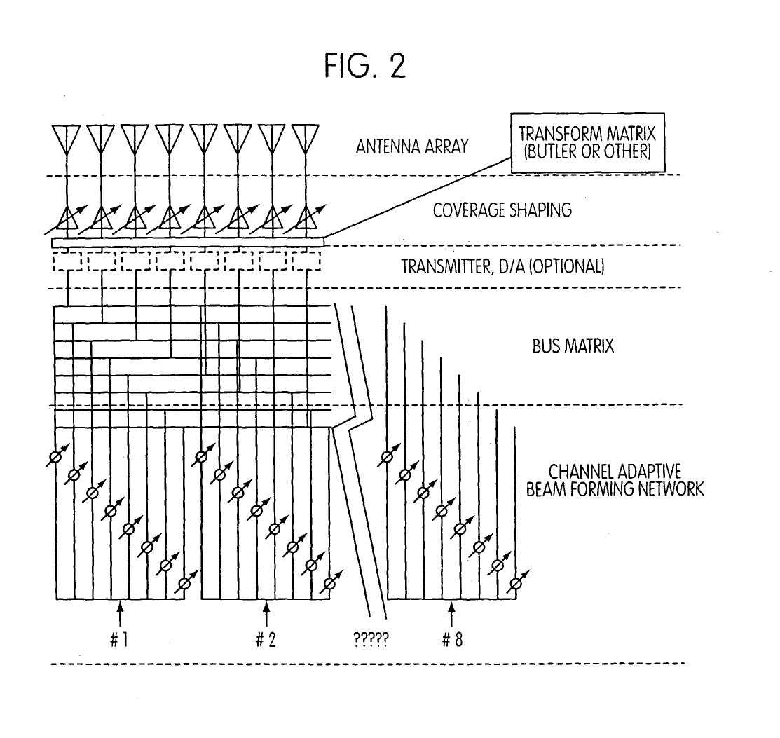

The Clever Antenna, illustrated in FIGS. 1-4, comprises two control layers for the beam forming: the “smart antenna” controls that form the beam for each link (according to the subscriber code), and the “clever antenna” controls that shape the envelope of all beams and defines or forms the cell boundary. A given antenna arrangement may be provided with control mechanism at one or both of these positions/planes.

Alternatively, the “clever antenna” control can be applied by properly controlling the individual controls of the “smart antenna”, thus avoiding the extra layer of RF controls (the coverage shaping layer).

The EIRP of the array in the direction θ (FIG. 1b) is

$$E I R P ( ϑ ) = {\sum }_{j} {W}_{j} {ⅇ}^{ⅈ k {d}_{i} sin ϑ} {\sum }_{i} {w}_{ij}$$

where

Wⱼ is the weight of the coverage shaping at the antenna element # j

K is the wave number

dⱼ is the distance of antenna element #j from a reference point on the array axis

$${\sum }_{i} {w}_{ij}$$

is the sum of the weights of the individual links (subscriber codes) #I

Thus, the coverage shaping weight Wⱼ may be applied by properly weighing each respective code weight by the value Wⱼ, namely

$$E I R P ( ϑ ) = {\sum }_{j} {ⅇ}^{ⅈ k {d}_{j} sin ϑ} {\sum }_{i} {w}_{ij} {W}_{j}$$

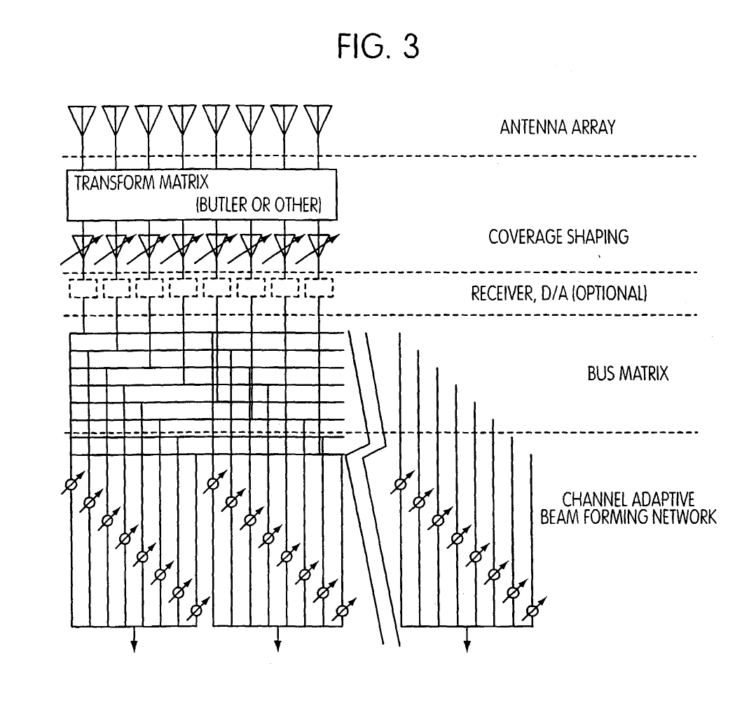

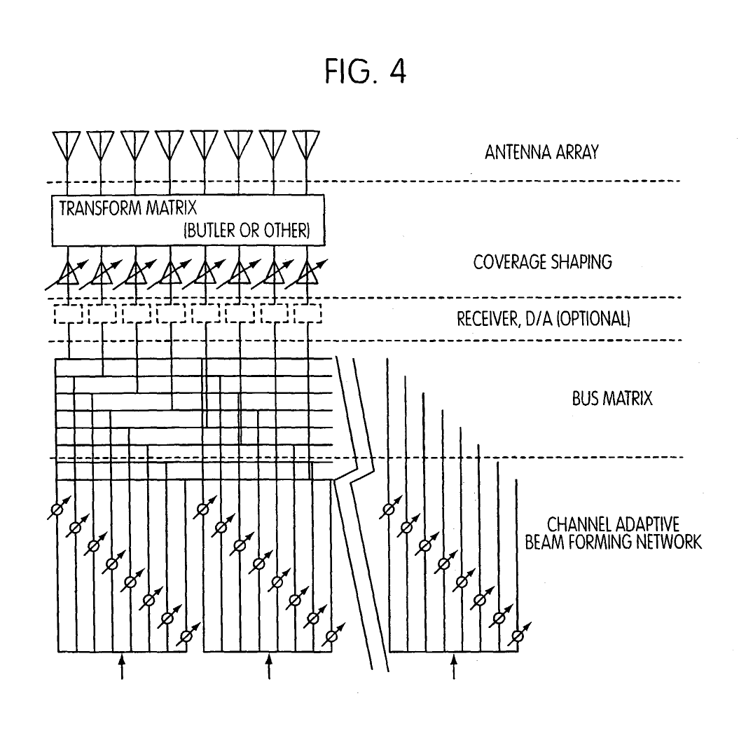

The same is true for the reverse link (FIG. 1) and for the transform case (FIGS. 3 and 4).

Non-Intrusive “Smart Antenna”

A conventional “smart antenna” forms a spatial matched filter for each code link by detecting the desired signal and adjusting the weights of all antenna elements so as to minimize the interference. This is an intrusive process. It is suggested here that an almost optimal process can be applied, one that is non intrusive.

Estimate of the ultimate spatial matched filter: the interference in a CDMA system consists of many small contributions from sources distributed within the cell, and from others outside the cell.

The ultimate matched filter will eliminate all interference sources outside a beam directed toward the vicinity of the desired source, and the beamwidth is limited by the physical size available for deployment of the array.

Considering an azimuthal beamwidth of 10 degrees, and considering it is designed to encapsulate the effect of angular dispersion caused by multipath scattering, the hypothetical gain value for such an array with no sidelobes is 36 (numerical), or 15.6 dB. This is an upper bound that may not be achievable by any physical array. If, on the other hand, one considers any typical practically realizable array where the average sidelobe level is lower than 15.6 dB, the gain of the (non-physical) ideal matched filter is only 3 dB higher than that of a typical array with the same beamwidth. The capacity gain within a cell for a practically fully adaptive array is only 10% higher than that of a beam pointing array, when there is a uniform distribution of subscribers within the cells. The beam pointing is effective for a given antenna array for such scenarios.

This analysis indicates that a sophisticated “smart antenna” does not offer more than a 3 dB, or 10%, improvement over a simple beam pointing array with a reasonable sidelobe level, for CDMA systems.

“Smart Antenna” Based on Position Location.

The position of each active subscriber will be available at the BTS as per the FCC requirement for furnishing accurate position location information for E911. With that information, beams can be formed in the direction of each active subscriber without employing an intrusive process. This is expected to achieve a level of performance close to that of the ultimate “smart antenna”. Its limitations may include:

The beam pointing typically has a slightly lower gain value, compared to the complex or “ultimate” adaptive antenna array, and the gain is about the same for cases where there is a uniform users distribution within the cell.

The beam pointing assumes that there is no substantial angular dispersion (multipath from other angles). The 10 degrees beamwidth encompasses most of the multipath in most environments.

Accordingly, a “smart antenna” can be made non-intrusive, given knowledge of the active subscribers' positions. A clever antenna can be non intrusive when the “clever” level of control operates in conjunction with the “smart” controls, either by applying a weight based on the gain of each beam or by physical weights as in FIGS. 1-4.

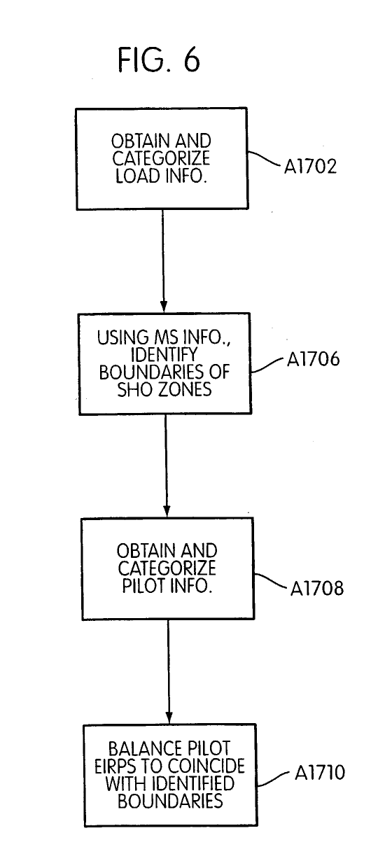

Referring to FIG. 6 for the reverse link, in a first act A1702, the optimization process first looks at the reverse link attributes, focusing on the load information regarding the number of subscribers/MSs that are communicating with the BS at a given time (i.e., active subscribers). This load information is obtained and categorized on a per sector basis as well as on a per beam basis when sector coverage is achieved by implementing a plurality of beam patterns. The categorization of the load information into sets corresponding to several beams corresponds to the multi-beam nature of certain embodiments of the present invention, for example, as shown in FIGS. 3C-7B of U.S. patent application Ser. No. 09/357,844, and described in the text corresponding thereto. In order to obtain the load information on a per beam basis, various methods may be used, including, placing a special sensor in a BS receiver which measures incident power on the reverse link and/or using subscriber reporting information obtained from the MSs. The load information is then related to geographic position information (e.g., one common digital representation of a geographic map).

The geographic map may comprise a two-dimensional representation of the geography and the location of various items with respect to that geometry, including, e.g., the cells, sectors, beam patterns, MS locations, and BS locations.

In a next act A1706, for a given cell cluster (e.g., three adjacent cells as shown in FIG. 16 of U.S. patent application Ser. No. 09/357,844), a determination using MS information (e.g., information concerning the locations and power levels of respective MSs within pertinent areas) is then made as to where the boundary line exists between adjacent cells or sectors. These boundary lines demarcate the hand-off boundaries, which correspond to the center of the soft hand-off zones. (For example, as shown as SH1, SH2, SH3, and SH4 for the reverse link in FIG. 16 of U.S. patent application Ser. No. 09/357,844).

The BS optimization process then focuses on the forward link attributes and performs certain pilot-related processes. Existing BSs transmit both traffic and pilot signal information over the forward link, and subscribing MSs measure the pilot signal strengths for all pilot signals it receives. When a new pilot signal exceeds a certain strength “threshold,” the MS may be instructed to enter into a soft hand-off mode (i.e., SH1, SH2, SH3, and SH4) with that new pilot.

When a MS locks onto a new pilot, it enters into what is generally referred to as a “soft hand-off window.” Within this window, there exist a virtual “power-distance” boundary between the adjacent cells. Generally, when the MS reaches that boundary, it will reach a point at which it can switch over to the new coverage area/cell. However, there are instances in which the virtual power-distance boundary falls too close to one of the borders of the soft hand-off window. This can be problematic and result in the loss of the call. Such losses occur, for example, when the MS does not switch to the new pilot in time and travels into the new cell with the old pilot signal.

In act A1708, the illustrated optimization algorithm performs pilot signal processing on the forward link and determines pilot signal power levels with respect to positions on the geographic map. It is noted that a separate “breathing” (i.e., changing over time) map will be provided for the forward link as well as for the reverse link. These breathing maps respectively represent, the forward link and reverse link radiation beam patterns pertaining to the positions and boundaries of the cells and sectors at certain times.

In act A1710, the optimization algorithm adjusts the power levels of the pilot signals of two adjacent BSs so that they are equal/balanced at a location which coincides with the corresponding mapped boundary line identified in act A1706 using reverse link information. Such a boundary line may be depicted on a geographic map by a line along the center of the soft hand-off zones. For example, as seen in FIG. 16 of U.S. patent application Ser. No. 09/357,844, such a boundary line may be depicted on a geographic map by a line along the center of the soft hand-off zones SH1, SH2, SH3, and SH4.

The directional antenna subsystem controller may instruct beam shaping subsystem to adjust the shape of certain individual beam patterns, which causes the pilot signal levels to be modified at certain locations near a hand-off zone area. This may be controlled to force the virtual power-distance boundary to move closer to the center of the soft hand-off window.

Referring back to act A1708, a geographic map of the varying pilot signal power levels may be obtained, for example, by using the pilot information reported by the MSs. As positional information regarding the MSs is provided in newer systems, the locations of the MSs will be easier to identify. However, with present systems, specific positional information regarding each MS is not readily obtainable. Accordingly, an algorithm may be utilized to correlate the pilot signal information obtained by the respective MSs corresponding to a particular area and to identify the location of the MS from which the pilot signal information was obtained. This facilitates the calculation of the pilot signal power level at certain locations on the map. The algorithm may identify the sector the MS is located in, obtain pilot signal power levels in adjacent sectors, correlate the pilot signal information from MSs for pilot signals that are within 5 dB from each, and aggregating those pilots.

Based on the mapped pilot signal information obtained at act 1708, the soft hand-off “islands” are now identifiable based upon forward link information. In act A1710, these soft hand-off “islands” (which comprise hand-off areas determined from a forward link perspective) are compared to the boundary lines obtained from reverse link information in act 1706, and the levels of the pilot signals within each of these corresponding areas (i.e., within the hand-off zones (reverse link) and within the hand-off islands (forward link)) are compared to a threshold. Those above the threshold are pilots that may be used by an MS falling within those overlapping areas to perform a hand-off.

If the number of pilots within the given overlapping area is greater than an allowable number (e.g., three pilots), this might indicate the occurrence of pilot pollution which can have deleterious effects on the performance of the network in that area, e.g., resulting in dropped calls or unsuccessful attempts to access the network.

The algorithm will make a decision to ignore certain pilots so the the number of pilots drops to or below the allowable number. Beam rearrangement or shaping may be performed to reduce the number of pilots, i.e., to reduce the levels of the “ignored” pilots, so that for any soft hand-off zone area there is a maximum number allowed pilots (e.g., three pilots).

To adjust the power levels for the given zone area, the optimization algorithm adjusts the EIRP of those pilots. This may be achieved by adjusting the power allocated to the pilot signal (which will have an equal effect throughout the whole area served by that pilot) and/or by adjusting the antenna gain. Adjusting the power allocated to the pilot signal affects the entire sector while adjusting the antenna gain may be controlled so as to affect individual beams within a given sector (i.e., beam shaping). The power allocated to a pilot signal may be changed at the BS, but requires upgrading the BS software. Alternatively, the total transmit power of the BS may be changed. In this manner, the power control of the BS recovers the power level for each traffic channel while the pilot signal power remains unchanged.

While the invention has been described with reference to the certain illustrated embodiments, the words which have been used herein are words of description, rather than words or limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. A method for optimizing boundaries of a subregion corresponding to one of a cell and a sector, said method comprising:
obtaining and categorizing load information for plural adjacent subregions, said load information comprising respective figures representing numbers of mobile stations communicating within the adjacent subregions;
using said mobile station information to identify reverse link boundary location information between the adjacent subregions;
obtaining and categorizing pilot information to identify forward link boundary location information; and
operating a directional antenna subsystem controller to adjust the shape of certain individual beam patterns, causing the forward link boundary location to coincide substantially with the reverse link boundary location.
